(19) United States
(12) Patent Application Publication
(10) Pub. No.: US 2015/0100953 A1
(43) Pub. Date: Apr. 9, 2015

(54) ELECTRONIC CONTROL DEVICE FOR VEHICLE AND METHOD OF CONTROLLING VEHICLE

(71) Applicant: Hyundai Motor Company, Seoul (KR)

(72) Inventors: Sangjin Yim, Seoul (KR); Chang Yu Kim, Bucheon (KR); Jea Myoung Youn, Suwon (KR)

(73) Assignee: Hyundai Motor Company, Seoul (KR)

(21) Appl. No.: 14/138,678

(22) Filed: Dec. 23, 2013

(30) Foreign Application Priority Data
Oct. 8, 2013 (KR) 10-2013-0120125

(51) Int. Cl. G06F 9/445; G06F 9/44

(52) U.S. Cl. CPC G06F 8/65; G06F 8/71
USPC 717/170

(57) ABSTRACT

An electronic control device for a vehicle and a method of controlling the vehicle are provided. The electronic control device includes a communication unit that is connected to an electronic control device of a second vehicle and transmits data thereto. A memory stores a first program that controls a first vehicle and a controller executes predetermined processes. The predetermined processes include receiving version data of a second program that controls the second vehicle via the communication unit and comparing a version of the second program with a version of the first program. The first program is transmitted to the electronic control device of the second vehicle via the communication unit to operate the second vehicle using the first program when the version of the first program is newer than that of the second program.

### CROSS-REFERENCE TO RELATED APPLICATION

This application claims priority to and the benefit of Korean Patent Application No. 10-2013-0120125 filed in the Korean Intellectual Property Office on Oct. 8, 2013, the entire contents of which are incorporated herein by reference.

### BACKGROUND

(a) Field of the Invention

The present invention relates to an electronic control device for a vehicle and a method of controlling the vehicle. More particularly, the present invention relates to an electronic control device for a vehicle and a method of controlling the vehicle that transmits a program controlling another vehicle using communication between vehicles.

(b) Description of the Related Art

Vehicles may include an electronic control device (e.g., electronic control unit (ECU)) that monitors and controls each state of an engine, an automatic transmission, an anti-skid braking system (ABS), and the like, to operate a vehicle and improve stability of the vehicle based on a running state. The electronic control device may respond to signals of various sensors installed within a vehicle and operate various actuators therein based on a predetermined logic to operate various apparatuses installed within the vehicle. In other words, the electronic control device may operate ignition timing of an engine, fuel injection, and engine idle, and set a predetermined limit value. The electronic control device may also operate a driving system, a braking system, a steering system, and so on.

The electronic control device may include an input port, a microcontroller unit (MCU), a memory, and an output port. The input port is configured to receive state information of a vehicle associated with state change of the actuators, the MCU is configured to calculate the state information of the vehicle in real time using predetermined programmed logic to operate each of the actuators, and the memory is configured to store information used to operate the actuators. The output port is configured to control signals from the MCU to the actuators.

As described above, the electronic control device may operate overall operation of a vehicle using various programs that operate the vehicle. However, even similar types of vehicles may use electronic control devices on which programs of different versions are installed. Accordingly, technology is required that may update an old version program to a new version program.

The above information disclosed in this section is only for enhancement of understanding of the background of the invention and therefore it may contain information that does not form the prior art that is already known in this country to a person of ordinary skill in the art.

### SUMMARY

The present invention provides an electronic control device for a vehicle and a method of controlling the vehicle that may update a second program that operates another vehicle using a first program that operates the vehicle. The present invention further effort provides an electronic control device for a vehicle and a method of controlling the vehicle that updates a program operating a vehicle by a one-time connection.

Technical objects to be achieved in the present invention are not limited to the above-described technical objects, and other technical objects that are not described may be clearly understood by those skilled in the art from the following description.

An exemplary embodiment of the present invention provides an electronic control device for a vehicle that may include: a communication unit configured to be connected to an electronic control device of another vehicle and transmit data to the other vehicle; a memory configured to store a first program that operates the vehicle; and a controller configured to process predetermined processes, wherein the predetermined processes may include receiving version data of a second program that operates the other vehicle via the communication unit, comparing a version of the second program with a version of the first program, and transmitting the first program to the electronic control device of the other vehicle via the communication unit to cause the first program to operate the other vehicle when the version of the first program is newer than that of the second program.

The controller may be configured to request the version data of the second program from the electronic control device of the other vehicle. In addition, the controller may be configured to transmit the comparison result to the electronic control device of the other vehicle. The communication unit may be configured to communicate with the electronic control device of the other vehicle using an on board diagnostics (OBD) communication protocol.

Another embodiment of the present invention provides a method of controlling a vehicle that may include: receiving, by a controller, version data of a second program that operates another vehicle from an electronic control device of the other vehicle; comparing, by the controller, a version of the second program with a version of a first program that operates the vehicle using the version data of the second program; and transmitting, by the controller, the first program to the electronic control device of the other vehicle to cause the first program to operate the other vehicle when the version of the first program is newer than that of the second program.

The method may further include requesting, by the controller, the version data of the second program from the electronic control device of the other vehicle and transmitting a comparison result to the electronic control device of the other vehicle.

According to at least one of exemplary embodiments of the present invention, it may be possible to update another program that controls another vehicle using a program that controls a vehicle being driven. Advantages and effects of the present invention are not limited to the advantages and effects as mentioned herein, and any other technical effects not mentioned herein may be clearly understood by a person skilled in the art to which the present invention pertains from the foregoing description.

### BRIEF DESCRIPTION OF THE DRAWINGS

FIG. 1 is an exemplary block diagram illustrating electronic control devices of a first vehicle and a second vehicle according to an exemplary embodiment of the present invention; and

FIG. 2 is an exemplary flowchart illustrating a method of controlling a vehicle according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter, an electronic control device for a vehicle and a method of controlling the vehicle according to an exemplary embodiment of the present invention will be described in more detail with reference to the accompanying drawings. In the following description, usage of descriptors such as “module”, “part”, or “unit” for referring to elements is merely to facilitate explanation of the present invention, without having any significant meaning by themselves.

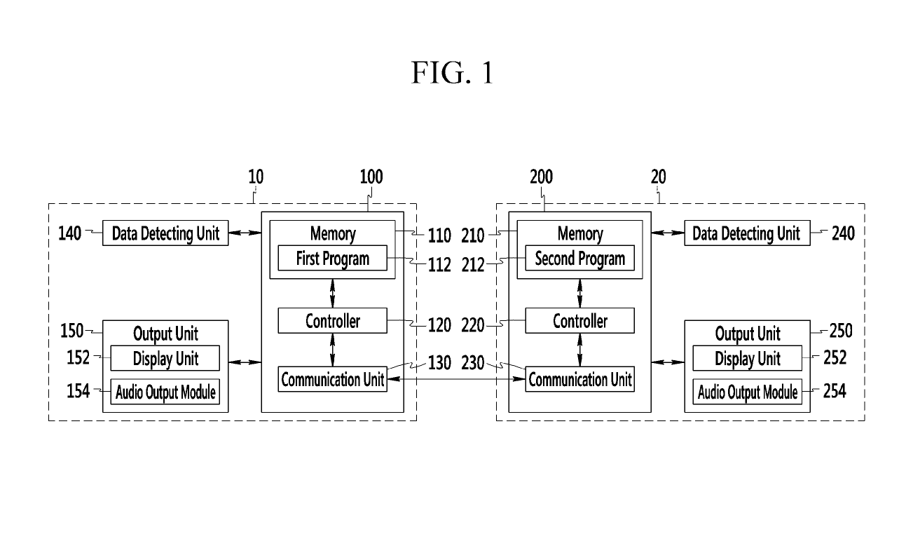

FIG. 1 is an exemplary block diagram illustrating electronic control devices of a first vehicle 10 and a second vehicle 20 according to an exemplary embodiment of the present invention. A first electronic control device 100 included in the first vehicle 10 will be described. The electronic control device 100 may include a memory 110, a controller 120, and a communication unit 130.

The memory 110 may be configured to temporarily store a first program 112 that may be executed by the controller 120 (e.g., a first controller) and input and output data. The memory 110 (e.g., a first memory) may be configured to store frequencies of use for each of the data. The memory 110 may include at least one of a flash memory, a hard disk memory, a multimedia card micro memory, a card memory (e.g., SD or XD memory, etc.), a random access memory (RAM), a static random access memory (SRAM), a read-only memory (ROM), an electrically erasable programmable read-only memory (EEPROM), a programmable read-only memory (PROM), a magnetic memory, a magnetic disk memory, and an optical disk memory.

The controller 120 may be configured to operate the first electronic control device 100. For example, the controller 120 may be configured to determine a driving tendency of a driver based on state data of a vehicle collected by a data detecting unit 140, and operate an engine (not shown) and an automatic transmission (not shown).

The communication unit 130 (e.g., a first communication unit) may include at least one module that performs wireless communication between a vehicle and a wireless communication network or between networks installed within vehicles. For example, the communication unit 130 may include a local interconnect network (LIN) communication module, an on-board diagnostics (OBD) communication module, a mobile communication module, a wireless Internet module, and a local area communication module. Accordingly, the communication unit 130 may be connected to another vehicle (e.g., the second vehicle 20) to transmit and receive information. More particularly, the communication unit 130 may be configured to receive information from the second electronic control device 200 of the second vehicle 20, and transmit information of the first electronic control device 100 of the first vehicle 10 to the second electronic control device 200.

The first electronic control device 100 may be connected to the data detecting unit 140 (e.g., a first data detecting unit) and an output unit 150 (e.g., a first output unit). The data detecting unit 140, executed by the controller 120, may be configured to detect data to determine a running state of the first vehicle and a driving tendency of the driver. The data detected by the data detecting unit 140 may be transmitted to the first electronic control device 100. The data detecting unit 140 may include an accelerator pedal position sensor, a vehicle speed sensor, a shift-speed sensor, an acceleration sensor, a steering angle sensor, a brake pedal position sensor, a global positioning system (GPS) sensor, a distance sensor, and an imaging device.

The accelerator pedal position sensor may be configured to detect or measure a degree of pressing of an accelerator pedal by a driver (e.g., the engagement pressure of the accelerator). In other words, the accelerator pedal position sensor may be configured to detect data regarding the driver's intention of accelerating a vehicle. The vehicle speed sensor may be configured to detect a vehicle speed, and may be mounted to a wheel of the vehicle.

Meanwhile, a target shift stage may be calculated based on a signal of the accelerator pedal position sensor and a signal of the vehicle speed sensor using a shift pattern, and gear shifting to the target shift stage may be controlled. For example, for an automatic transmission that includes a plurality of planetary gear sets and a plurality of friction elements, hydraulic pressure, which is supplied to the plurality of friction elements or released from the plurality of friction elements, may be adjusted. In addition, for a double clutch transmission, a current, which is applied to a plurality of synchronizers and an actuator, may be adjusted.

The shift-speed sensor may be configured to detect a shift stage that is currently engaged. The acceleration sensor may be configured to detect acceleration of the vehicle. In addition to the vehicle speed sensor, the acceleration sensor may be mounted to directly detect acceleration of the vehicle, or acceleration of the vehicle may be calculated by differentiating the vehicle speed detected by the vehicle speed sensor. The steering angle sensor may be configured to detect a steering angle of the vehicle. In other words, the steering angle sensor may be configured to detect a running direction of the vehicle (e.g., in the direction that the vehicle is heading or directed towards). The brake pedal position sensor may be configured to detect whether the brake pedal is engaged. In other words, the brake pedal position sensor may be configured to detect an acceleration intention together with the accelerator pedal position sensor.

The GPS sensor may be a sensor configured to determine a location of the vehicle. In particular, the GPS sensor may be configured to calculate information regarding distances from three or more satellites and time information and apply trigonometry to the calculated information to accurately calculate three-dimensional (3D) current location information based on latitude, longitude, and altitude. Currently, a method of calculating location and time information using three satellites and correcting an error of the calculated location and time information using a single satellite is commonly used.

Additionally, the GPS sensor may be configured to calculate information regarding a speed of a vehicle by continuously calculating a current location of the vehicle in real time. The distance sensor may be configured to detect a distance between the vehicle being driven and a forward vehicle. As the distance sensor, various sensors such as an ultrasonic wave sensor or an infrared sensor may be used. The imaging device (e.g., camera, video camera, etc.) may be configured to capture images of the surroundings around the vehicle. For example, the imaging device may be installed at the front or the rear of the vehicle, and may be configured to capture images of a road, other vehicles, and pedestrians. In addition, the imaging device may be installed at one side of the vehicle, and may be configured to capture images around the one side of the vehicle.

Further, the data detecting unit 140 may include a temperature sensor, a humidity sensor, a rain sensor, and a gravity sensor associated with a state of the vehicle. Data sensed by the data detecting unit 140 may be output to the first electronic control device 100. The output unit 150 may include a display unit 152 (e.g., a first display unit 152) and an audio output module 154 to generate visual and/or auditory output. In particular, the display unit 152, executed by the controller 120, may be configured to display information processed in the vehicle. For example, when the vehicle is in a running mode, the display unit 152 may be configured to display a user interface (UI) or graphical user interface (GUI) related to the running of the vehicle. When the vehicle is in a parking state, the display unit 152 may be configured to display an image captured by the imaging device or a UI and/or a GUI related to the parking state. The display unit 152 may include at least one of a liquid crystal display (LCD), a thin film transistor liquid crystal display (TFT LCD), an organic light-emitting diode (OLED), a flexible display, and a 3-dimensional display.

Some of the above-mentioned displays may be formed as a transparent or light transmissive type to view the exterior therethrough. Such displays may be referred to as a transparent display, and a representative example of the transparent display may include a transparent OLED (TOLED). The rear structure of the display unit 152 may also be formed as a light transmissive type. Based on the structure, the driver may view objects located at the rear of the display unit 152. A vehicle may include two or more display units 152 according to the structure of the vehicle. For example, the display unit 152 may be disposed at seats and a center fascia of the vehicle, respectively.

When the display unit 152 is formed as an interactive layer structure or an integrated type together with a touch sensor (hereinafter referred to as “touch screen”), the display unit 152 may be used as an input device as well as an output device. When the touch sensor, for example, includes at least one of a touch film, a touch sheet, and a touch pad, the touch sensor may be accumulated in the display unit 152 to form a layer structure or may be included in the display unit 152 to be integrated with the display unit.

The touch sensor may be formed to convert a pressure or capacitance change at a specific portion of the display unit 152 to an electrical input signal. The touch sensor may be formed to detect a point and a portion to be touched and a pressure thereon. When an input is on the touch sensor, a corresponding signal(s) may be transmitted to a touch controller (not shown). The touch controller may be configured to process the corresponding signal(s), and transmit corresponding data to the controller 120. Therefore, the controller 120 may be configured to recognize that a point or portion of the display unit 152 is touched. The audio output module 154 may be configured to receive audio data from the communication unit 130 or output audio data stored in the memory 110 according to state information, or control signals of a vehicle in a running or parking mode. The audio output module 154 may include a receiver, a speaker, a buzzer, and so on.

A second electronic control device 200 of the second vehicle 20 may be formed in the same manner as the first electronic control device 100 of the first vehicle 10 as described above. However, a memory 210 (e.g., a second memory) of the second electronic control device 200 may be configured to store a second program 212 to process and operate related to the controller 120 (e.g., the first controller). The first program 112 and the second program 212 may be the same types of program, but may be different versions of the program. For example, the first vehicle 10 with the first program 112 may be manufactured more recently than the second vehicle 20 with the second program 212, and the first program 112 may be a newer version than that of the second program 212.

In the above case, the first vehicle 10 and the second vehicle 20 may be the same type of vehicle model. In addition, even when the vehicles are different types of models, the controllers 120 and 220 may operate by the same program.

The communication unit 130 of the first vehicle 10 and a communication unit 230 (e.g., a second communication unit 230) of the second vehicle 20 may be connected via the OBD protocol, to receive and transmit data between each other. The second vehicle 20 may further include a data detecting unit 240 (e.g., a second data detecting unit).

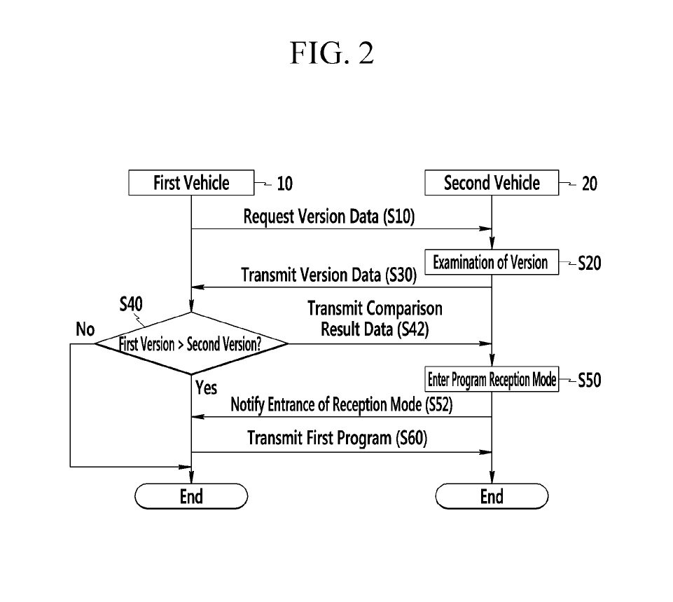

Hereinafter, a method of transmitting the first program 112 to the second vehicle 20 when the communication unit 230 of the second vehicle 20 and the communication unit 130 of the first vehicle 10 are connected, will be described in detail with reference to FIG. 2. FIG. 2 is an exemplary flowchart of a method of controlling a vehicle according to an exemplary embodiment of the present invention.

The controller 120 of the first vehicle 10 may be configured to request version data of the second program 212 from the second vehicle 20 via the communication unit 130 of the first vehicle at step S10. Then, a controller 220 of the second vehicle 20 may be configured to determine the version of the second program 212 stored in the memory 210 at step S20, and transmit the determined version data of the second program 212, via the communication unit 230 of the second vehicle, to the first vehicle 10 at step S30.

Further, the controller 120 of the first vehicle 10 may be configured to compare the version of the second program 212 with the version of the first program 112 using the identified version data of the second program 212 at step 40. While doing so, the controller 120 of the first vehicle 10 may be configured to determine the version of the first program 112 stored in the memory 110, and determine whether the first program 112 and the second program 212 are the same (e.g., substantially similar) type of program using the version data of the second program 212.

The controller 120 of the first vehicle 10 may be configured to transmit a result of comparing the version of the second program 212 with the version of the first program 112 to the second vehicle 20 via the communication unit 130 at step S42. Then, the controller 220 of the second vehicle 20 may be configured to enter a receipt mode to receive the first program 112 based on the comparison result at step S52, and transmit a completion signal of entering the receipt mode to the first vehicle at step 52.

When the version of the first program 112 is newer (e.g., produced or updated more recently) than that of the second program 212 and the controller 120 receives the completion signal of the entering the receipt mode from the controller 220, the controller 120 may be configured to transmit the first program 112 to the second vehicle at step S60. Then, the controller 220 of the second vehicle 20 may be configured to store the first program 112 in the memory 210. The controller 220 of the second vehicle 20 may be configured to inform a user of receipt completion of the first program via an output unit 250. Therefore, the controller 220 of the second vehicle 20 may be configured to operate the second vehicle 20 using the first program 112. The output unit 250 may include a display unit 252 and an audio output module 254, executed by the controller 220, to generate visual and/or auditory output.

While this invention has been described in connection with what is presently considered to be exemplary embodiments, it is to be understood that the invention is not limited to the disclosed embodiments, but, on the contrary, is intended to cover various modifications and equivalent arrangements included within the spirit and scope of the accompanying claims.

Description of Reference Numbers

| | |
|---|---|
| 10: first vehicle | 20: second vehicle |
| 100: first electronic control device | 110: memory |
| 120: controller | 130: communication unit |
| 140: data detecting unit | 150: output unit |
| 200: second electronic control device | 210: memory |
| 220: controller | 230: communication unit |
| 240: data detecting unit | 250: output unit |

What is claimed is:

1. An electronic control device for a vehicle, comprising:
a communication unit configured to be connected to an electronic control device of a second vehicle and transmit data to the second vehicle;
a memory configured to store a first program that operates a first vehicle; and
a controller configured to execute predetermined processes, the predetermined processes when executed configured to:
receive version data of a second program that operates the second vehicle via the communication unit;
compare a version of the second program with a version of the first program; and
transmit the first program to the electronic control device of the second vehicle via the communication unit to operate the second vehicle using the first program when a version of the first program is newer than a version of the second program.

2. The electronic control device of claim 1, wherein the predetermined processes when executed are further configured to:
request the version data of the second program from the electronic control device of the second vehicle.

3. The electronic control device of claim 1, wherein the predetermined processes when executed are further configured to:
transmit a comparison result to the electronic control device of the second vehicle.

4. The electronic control device of claim 1, wherein the communication unit is configured to communicate with the electronic control device of the second vehicle using an on board diagnostics (OBD) communication protocol.

5. The electronic device of claim 1, wherein the communication unit is configured to communicate wirelessly between the first vehicle and the second vehicle.

6. The electronic device of claim 5, wherein the communication unit includes a local interconnect network (LIN) communication module, an on-board diagnostics (OBD) communication module, a mobile communication module, a wireless Internet module, and a local area communication module

7. A method of controlling a vehicle, comprising:
receiving, by a controller, version data of a second program that operates a second vehicle from an electronic control device of the second vehicle;
comparing, by the controller, a version of the second program with a version of a first program that operates a first vehicle using the version data of the second program; and
transmitting, by the controller, the first program to the electronic control device of the second vehicle to operate the second vehicle using the first program when a version of the first program is newer than a version the second program.

8. The method of claim 7, further comprising:
requesting, by the controller, the version data of the second program from the electronic control device of the second vehicle.

9. The method of claim 7, further comprising:
transmitting, by the controller, a comparison result to the electronic control device of the second vehicle.

10. A non-transitory computer readable medium containing program instructions executed by a controller, the computer readable medium comprising:
program instructions that receive version data of a second program that operates a second vehicle from an electronic control device of the second vehicle;
program instructions that compare a version of the second program with a version of a first program that operates a first vehicle using the version data of the second program; and
program instructions that transmit the first program to the electronic control device of the second vehicle to operate the second vehicle using the first program when a version of the first program is newer than a version the second program.

11. The non-transitory computer readable medium of claim 10, further comprising:
program instructions that request the version data of the second program from the electronic control device of the second vehicle.

12. The non-transitory computer readable medium of claim 10, further comprising:
program instructions that transmit a comparison result to the electronic control device of the second vehicle.
